(19) United States
(12) Patent Application Publication
(10) Pub. No.: US 2005/0075957 A1
(43) Pub. Date: Apr. 7, 2005

(54) Balance management for pre-paid services

(76) Inventors: Simon Pincus, Brisbane (AU); Mark Myatt, Brisbane (AU); Felim O'neill, Galway (IE); Malcolm Crouch, Ontario (CA); Michael Jenvey, Queensland (AU); Graham Agnew, Queensland (AU); Michael Rosenberg, Queensland (AU)

Correspondence Address: Nelson Mullins Riley & Scarborough;Attn: Kyle M Globerman, 1320 Main Street, Columbia, SC, 29201, US

(21) Appl. No.: 10/490,505

(22) PCT Filed: Sep. 20, 2002
(86) PCT No.: PCT/US02/30024

(30) Foreign Application Priority Data
Sep. 20, 2001 (US) 60323896
Sep. 20, 2001 (US) 09960261

(51) Int. Cl. G06F 17/60

(52) U.S. Cl. 705/35

(57) ABSTRACT

A computerized balance management system includes a balance manager that maintains a database having pre-paid accounts. The accounts will have data such as account balance and other account configuration data. The system also communicates with a plurality of servers that are coupled to a mobile network. The servers may include a content server, a mobile commerce server, or an intelligent network platform server. The balance manager is operative to perform the tasks of receiving queries from at least one of the plurality of servers, calculating a reservation amount based on the query and reserving the reservation amount against the pre-paid account.

### CROSS-REFERENCE TO RELATED APPLICATIONS

This application claims the benefit of U.S. Provisional Application No. 60/323,896, entitled “BALANCE MANAGEMENT FOR PREPAID SERVICES” and filed Sep. 20, 2001, and is related to copending and coassigned U.S. patent application Ser. No. 09/960,261 entitled “REAL-TIME RESERVATION OF CHARGES FOR PRE-PAID SERVICES” and filed Sep. 20, 2001, both of which are hereby incorporated herein by reference for all purposes.

### FIELD

The present invention relates generally to computerized systems for maintaining pre-paid service, and more particularly to reserving charges against pre-paid services.

### BACKGROUND

Mobile network services continue to evolve at a rapid pace. With each new generation, more services and features are incorporated in mobile devices such as cellular phones and wireless computing devices. There is a continuing trend towards a convergence of Internet, mobility, media and broadband features in these mobile devices. As an example, the current generation of mobile devices, referred to as 3G (third generation) mobile devices, are capable of providing voice services, text messaging services, Internet networking services, and multimedia content services.

In the past, these services have been provided on a post-paid basis, or by dedicated pre-paid systems that were required for each category of service. For post paid services, as services are provided for a particular customer account, billing event data is collected regarding the service provided and stored in a database accessible to a computerized billing system. Periodically (typically monthly), a bill is sent to the customer that details the charges against the account for the services provided during the billing period. The services are thus post-paid because payment is made after the service is provided.

There has been rapid growth of pre-paid services. In pre-paid service environments, customers make payments up-front, that is, prior to the rendering of the service. As services are provided, the charges for the service are deducted from the account. If the account balance falls to zero, services are no longer provided until additional funds are added to the account. Pre-paid services provide advantages to both the customer and the service provider. The customer knows in advance the maximum they will be charged for service, because the charges will typically not exceed the pre-paid amount placed in the account. This is unlike post-paid service, where the charges against the customer's account are not known until the bill is received. Additionally, the service provider does not have to worry about the creditworthiness of the customer. Because amounts are pre-paid, the service provider is assured they will be compensated for the services provided.

However, there are several problems associated with pre-paid services. A first problem relates to services that are charged based on the duration or other metric associated with an event. For example, it is rarely the case that a user will know in advance how long a phone call will last, or how many bytes of data will be transferred during a data session. As a result, it is not possible to calculate a charge until the event is over. This results in the possibility that a user will incur a charge that is greater than the amount available in their pre-paid account. In order to guard against this possibility, previous systems, at the initiation of an event, have reserved the entire amount available in the account rather than waiting to calculate the charge at the end of the event.

A second problem relates to the fact that multiple users can be using services on multiple mobile devices associated with the same account. If the entire amount in the account is dedicated to a first user of the account, no other users can use services until the first user is done. For example, if a user A is using a mobile phone to make a phone call while user B is attempting to establish a wireless network session on a portable PC, user B will be denied service until user A completes their phone call.

A further problem is related to the multi-service nature of 3G systems. Traditionally, pre-paid services run on intelligent network (IN) servers. However, the 3G system can also concurrently use services provided by content servers and m-commerce (mobile commerce) servers.

In view of the above-described problems, there is a need in the art for the present invention.

### SUMMARY

The above-mentioned shortcomings, disadvantages and problems are addressed by the present invention, which will be understood by reading and studying the following specification.

In one embodiment a computerized balance management system includes a balance manager that maintains a database having pre-paid accounts. The accounts will have data such as account balance and other account configuration data. The system also communicates with a plurality of servers that are coupled to a mobile network. The servers may include a content server, a mobile commerce server, or an intelligent network platform server. The balance manager is operative to perform the tasks of receiving queries from at least one of the plurality of servers, calculating a reservation amount based on the query and reserving the reservation amount against the pre-paid account.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1A is a block diagram an operating environment in which different embodiments of the invention may be practiced;

FIG. 1B is a block diagram providing further details of the logical architecture of a balance management system according to an embodiment of the invention;

FIG. 2 is a flow diagram illustrating a method for reserving amounts against pre-paid services according to an exemplary embodiment of the invention;

FIG. 3 is a flow diagram illustrating a method for determining a reservation amount according to an exemplary embodiment of the invention;

FIG. 4 is a flow diagram illustrating a method according to an exemplary embodiment of the invention for providing customer controlled account selection in a pre-paid services environment;

FIG. 5 is a flow diagram illustrating a method according to an exemplary embodiment of the invention for providing customer controller spending limits;

FIG. 6 is a block diagram illustrating an exemplary configuration with customer controlled spending limits;

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense.

In the Figures, the same reference number is used throughout to refer to an identical component which appears in multiple Figures. Signals and connections may be referred to by the same reference number or label, and the actual meaning will be clear from its use in the context of the description.

The detailed description is divided into three sections. In the first section the operating environment of different embodiments of the invention is described. In the second section, the methods according to varying embodiments of the invention are described. In the final section, a conclusion is provided.

### Operating Environment

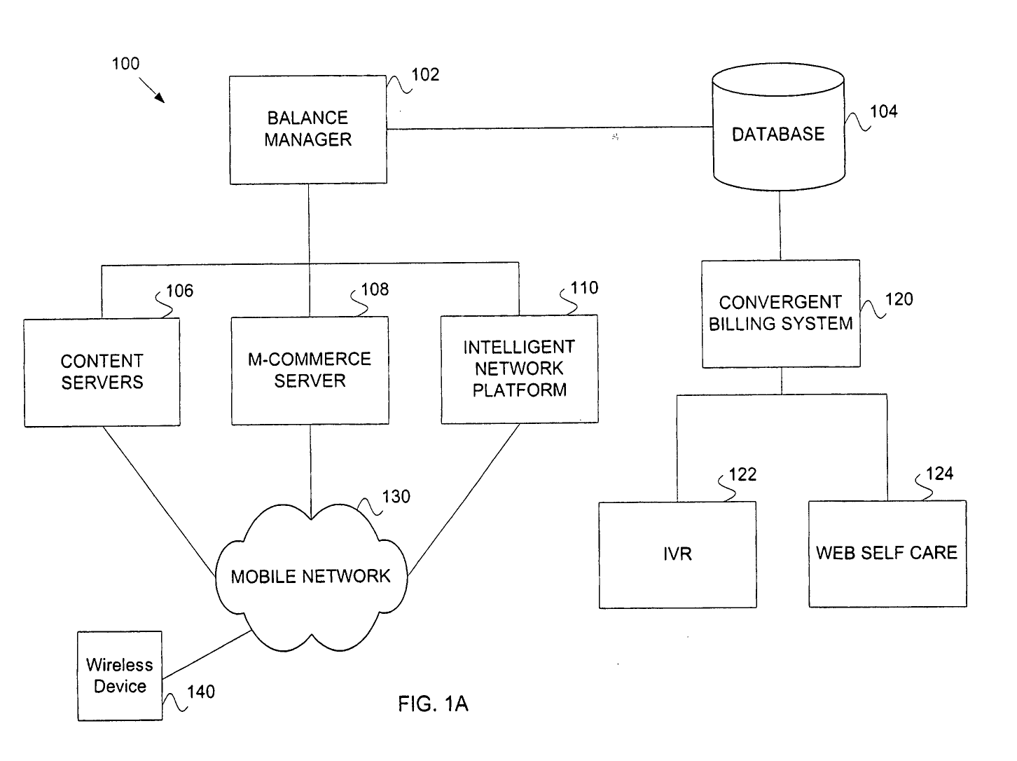

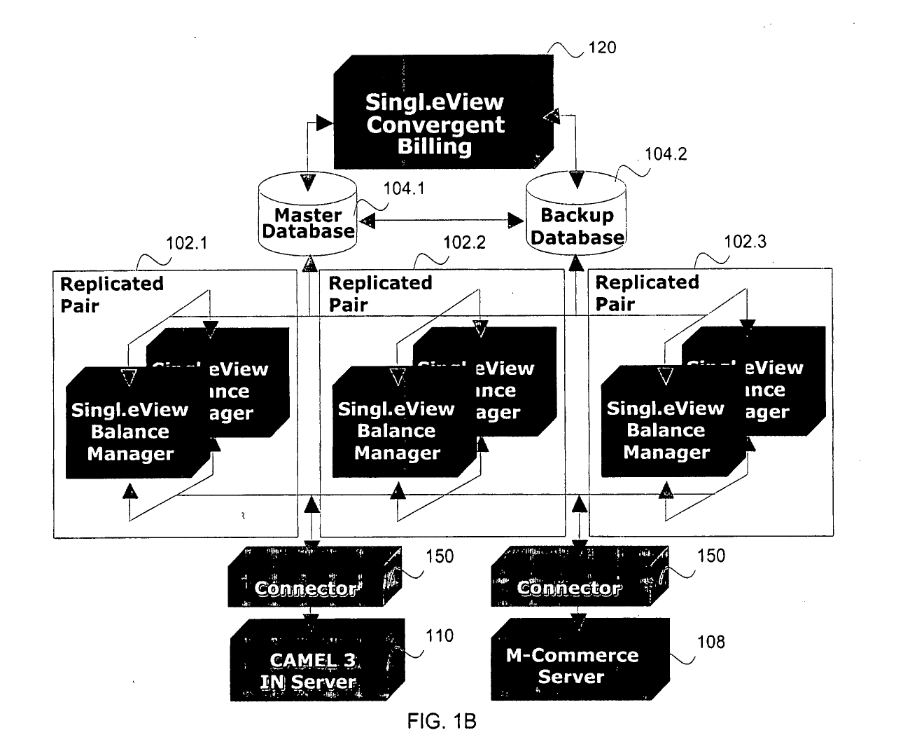

FIG. 1A illustrates an operating environment 100 in which embodiments of the invention may be practiced. As shown, environment 100 includes a balance manager 102 communicably coupled via a network to zero or more content servers 106, zero or more m-commerce servers 108, and zero or more intelligent network platforms 110. Content servers 106, m-commerce servers 108 and intelligent network platforms 110 are also communicably coupled to mobile network 130. In one embodiment of the invention, mobile network 130 is a wireless network that provides the ability to communicably couple a variety of wireless devices 140 with one another and with servers on the network 130. An example of such a network supports the GSM (Global System for Mobile Communications) standard. However, the invention is not limited to GSM type networks, and other wireless communications networks are within the scope of the invention. Examples of wireless devices include cellular phones, personal digital assistants (PDAs), and portable computers with wireless network interfaces. The invention is not limited to any particular wireless device.

Intelligent Network (IN) platform 110 comprises a computerized system capable of controlling and managing voice and data transport services on network 130. In addition to basic services such as managing voice and data connections, IN platform 110 can also provide services such as voice mail, e-mail notification, fax notification and paging. In one embodiment of the invention, IN platform 110 is a CAMEL3 (Customized Application of Mobile Enhanced Logic) platform.

An M-commerce server 108 comprises a server capable of supporting “m-commerce”, that is mobile commerce. Mobile commerce is a general term used to describe the buying and selling experience on the mobile network 130. M-commerce typically requires real-time authorization for purchases of goods and services made available through m-commerce server 108. The payment itself can be made in a number of ways, e.g. directly keying in a credit-card or debit card number and expiry date, by debiting an account associated with the user's wireless device 140.

A content server 106 comprises a server that provides video, audio, text based, and multi-media data that can be downloaded by devices on a network, including a wireless device 140. Additionally, content server 106 can be a game server. Often there is a charge associated with the downloading such content. For example, a user may be required to pay a subscription fee to access data on content server 106. Alternatively, the user may be charged a fee for each download of a content data file.

In addition to, or instead of the charging described above, each of the servers 106, 108 and 110 may calculate a charge based on service units. A service unit is a metric used to measure the quantity of a service being used. For example, the metric for a voice call or data connection may be duration based. In this case, the service unit is typically a quantity of time such as a second, minute, hour etc. Alternatively, the service unit for a data connection or download may be the number of bytes transmitted and/or received. Other examples of service units include tokens and messages. The invention is not limited to any particular type of service unit.

Balance manager 102 is a computerized system operable to provide account balance management and rating services. In one embodiment of the invention, balance manager 102 receives requests to authorize and apply charges against pre-paid services. Examples of such charges include charges incurred as a result of downloading content from content servers 106, purchasing goods and/or services through an m-commerce server 108, and connection and airtime charges for voice and data connections controlled by IN platform 110. In general, balance manager 102 receives requests to authorize charges against an account associated with a wireless device. In the case of some content and goods or services, the charge may be known up-front and authorization is a relatively simple matter of comparing the charge amount with the pre-paid balance for the account associated with the wireless device. However, in the case of content and other downloads that may have connection and airtime charges, the charged amount cannot be determined up-front, because the number of service units required for a particular event is not known until the event has terminated. In order to handle such cases, the balance manager 102 determines whether the event should be authorized. In addition, in some embodiments, the balance manager determines a number of service units to authorize and reserves a corresponding amount against the account. The reservation can be committed if the event completes successfully. Alternatively, the reservation can be cancelled if the event does not complete successfully. Furthermore, the reservation can expire if the event does not complete within a predetermined amount of time. Further details on the reservation process are provided in the next section.

Balance manager 102 is operably coupled to database 104. Database 104 maintains account information including an account identifier used to associate the account with one or more wireless devices and account balance information. Database 104 can be any type of database system known in the art, the invention is not limited to any particular database management system.

Convergent billing system 120 is also operably coupled to database 104. Convergent billing system uses the data in database 104 to provide billing data to customer and employees of the network provider. Billing system 120 can provide the data using an interactive voice response system (IVR)122 or through a web-based “self-care” system 124.

FIG. 1B is a block diagram providing further details of the logical architecture of a balance management system according to an embodiment of the invention. In some embodiments, database 104 comprises a master database 104.1, and a backup database 104.2. In these embodiments, master database 104.1 holds all subscriber data for a service provider, regardless of whether they are post-paid or pre-paid. The backup database 104.2 provides support for system resilience and is replicated from the master database 104.1. In some embodiments, replicated data includes:
subscriber account data
service information
product catalogue, and
tariff information

In some embodiments, backup database 104.2 can also be used by balance managers 102 as an event and charge store in the event that the master database 104.1 is unavailable.

In some embodiments, balance manager 102 includes the following components:
the balance management interface that external systems such as IN servers 110 and content servers 106 access. In some embodiments, these interfaces are comprised of general purpose interfaces as well as pre-built interfaces for specific applications e.g. HP Opencall IN platform.
caches of customer account balances and reservations as well as service details, product catalog and tariff information. This caching avoids database lookups during reservation requests.
rating engines to perform rating of events and ‘reverse rating’ for reservations (where monetary amounts need to be converted to volume or duration units).
business rules configured expressions that control the size of reservations and the account selection rules.

In some embodiments, each balance manager 102 can be replicated to form a replicated pair such as balance manager pair 102.1. In this way, the failure of any one balance manager server 102.x will not affect the balance management service being provided by other balance managers.

The balance management function can also be distributed across multiple servers, such as balance managers 102.1-102.3 to provide multi-server scalability. In some embodiments, to minimize coupling between servers, each server pair 102.x manages a specific set of accounts. A Mobile Network Operator (MNOP) may define the algorithm used to distribute accounts via expressions or business rules. It should be noted that while FIG. 1B shows three replicated pairs 102.1-102.3, the invention is not limited to any particular number of replicated pairs.

In some embodiments where subscriber accounts are being distributed across multiple balance manager servers 102, the balance manager connector 150 is used to direct messages to the correct balance manager server pair 102.x. The connector 150 receives incoming messages from requesting services, e.g. an M-Commerce server 108 or IN server 110, and forwards them to the correct balance manager server 102.x by translating the subscriber identifier to a logical server. The connector 150 forwards the message to the identified balance manager 102.x, automatically load balancing between both servers of the pair if replication is being used. The communication between the connector 150 and balance managers 102 can employ internal proprietary messaging or a third-party Enterprise Application Integration (EAI) messaging tool.

### Methods

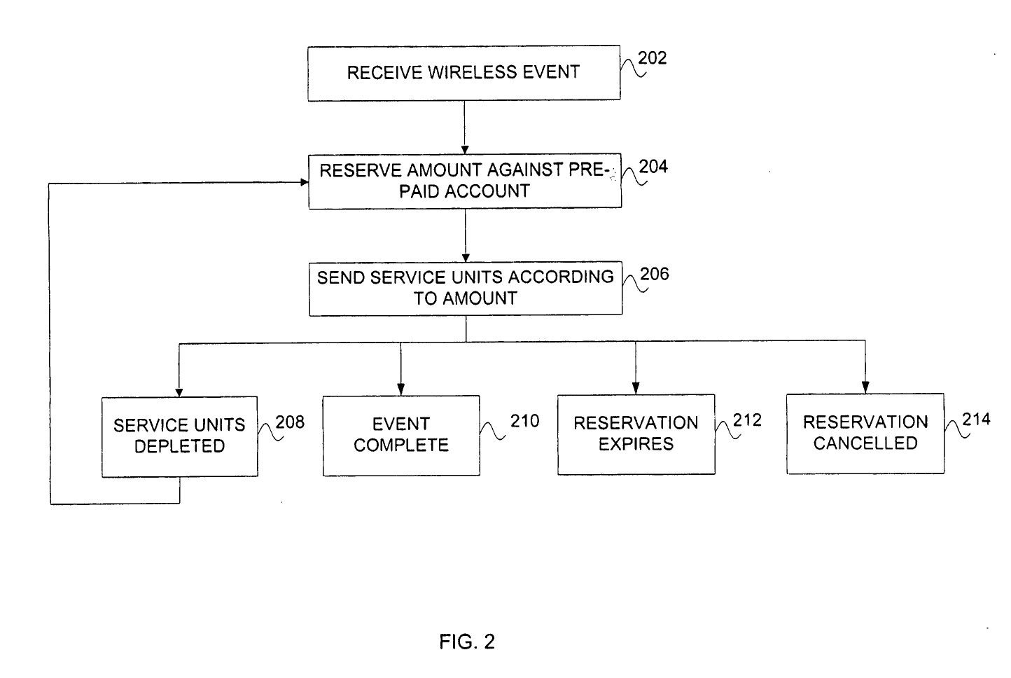

In this section, the particular methods executed by an exemplary embodiment are described by reference to a series of flowcharts shown in FIGS. 2-5. The methods to be performed by the operating environment constitute computer programs made up of computer-executable instructions. Generally such computer-executable instructions are loaded from a computer-readable medium such as a ROM, hard drive, floppy drive, CD-ROM, DVD-ROM, Flash Memory or other device capable of persistently storing the instruction. The instructions are typically loaded into a computer-readable medium such as RAM for execution.

Describing the methods by reference to a flowchart enables one skilled in the art to develop such programs including such instructions to carry out the methods on suitable computers (the processor of the computer executing the instructions from computer-readable media). The methods illustrated in FIGS. 2-5 are inclusive of the acts required to be taken by an operating environment executing an exemplary embodiment of the invention.

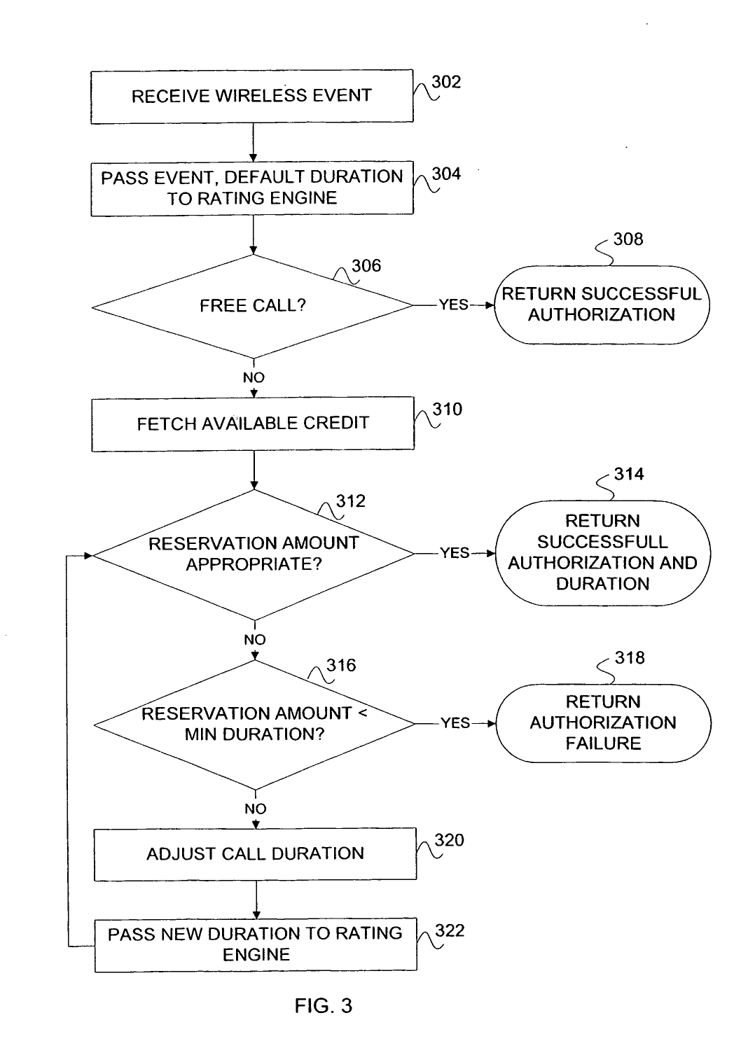

FIGS. 2-3 describe a process for reserving an amount against a pre-paid service, and a process for determining an appropriate amount to reserve that is referred to as “reverse rating.” Rating is generally a process by which a charge for an event such as a call or data connection is determined. Generally speaking, an event is rated by passing event parameters such as an event type and a quantity of service units. For example, a call event may be rated by passing call parameters such as duration and call type to a rating engine. The rating engine determines the appropriate tariff based on the type of the call (e.g. local, long distance, international) and the time that the call was placed, along with the duration of the call to determine the charge for the call. Rather than providing a charge for an event, reverse rating receives the type of event and a monetary amount and provides a corresponding quantity of service units that are authorized for the event. For example, reverse rating a wireless phone call event may include receiving a monetary amount and a call type, and providing a duration that is authorized for the call. Similarly, a reverse rating for a download event can include receiving a monetary amount and download type and providing a corresponding number of bytes that can be downloaded. Reverse rating can be applied to any type of service unit. For example, reverse rating may return a quantity of time, bytes, messages, or tokens that are authorized for use. In one embodiment of the invention, reverse rating is used to reserve amounts against a pre-paid account.

FIG. 2 is a flow diagram illustrating a method for reserving amounts against pre-paid services according to an exemplary embodiment of the invention. The method begins when a system executing the method receives a wireless event (block 202). The wireless event can signal the beginning of a voice call, a network session, a content download, a purchase event or other type of event. The invention is not limited to any particular type of event.

Next, the system executing the method reserves an amount against the pre-paid account. Typically the amount reserved will be less than the total amount available in the pre-paid account. This is desirable in order to allow multiple account users the opportunity to use the account to obtain services concurrently. Further details regarding the calculation of the reserve amount will be provided below in reference to FIG. 3. It should be noted that the reserved amount does not represent a committed charge, rather it represent an amount from the account that is not available for any other event while the reservation exists.

After the amount to reserve has been determined, the system determines the number of service units that should be authorized. In some embodiments of the invention, the service units are time units such as seconds, minutes or hours, and represent a duration for a call or data connection. The duration is calculated according to the amount reserved against the account. In addition, in some embodiments, the duration is also calculated according to the tariffs in effect for the type of call (e.g. local, long distance etc.). For example, if an amount equal to $10.00 has been reserved and the tariff is $0.20/minute, than a duration of 50 minutes will be authorized. In some embodiments, if the account does not have a minimum amount available to reserve, the event will not be authorized and the duration will be zero. In addition, the service units can represent a quantity of messages that are to be sent to and from the wireless device. As an example, if $10.00 has been reserved and there is a charge of $0.10/message, the 100 messages will be authorized. Data indicating the quantity of service units authorized is sent to the mobile device (block 206).

Blocks 208, 210, 212 and 214 represent possible alternatives that may occur after an amount has been reserved against an account and a quantity of service units authorized based on the reserved amount. Block 208 represents the depletion of the authorized service units before the event is complete. For example, a user may desire to talk on their mobile phone for a longer period of time than has been authorized. In this case, the system executing the method will receive a request to reserve a further amount against the pre-paid account and return to block 204. In some embodiments of the invention, if the credit remaining in the account falls below a threshold, a low credit warning may be issued to the mobile phone or other wireless device.

Alternatively, a reservation may be cancelled (block 214). In some embodiments, cancellation of a reservation results in the reservation amount being freed and made available for other events. As an example, a reservation may be made at the start of a content download, and authorized for the whole download. If the download fails before completion, the reservation may be cancelled.

Another alternative is that the reservation may expire prior to completion of the event, or before the event begins (block 212). In some embodiments, reservations may be configured with an expiry date and/or time. The expiry date and time can be in absolute terms, or it can be in relative terms. In these embodiments, upon expiration, a reservation is cancelled and the reservation amount freed for other events. As an example, assume that a reservation may be made for a content download and, for purposes of the example, reservations are configured to expire after two hours. Further assume that due to a system failure, the download never takes place, and that the content server does not request cancellation of the reservation. In this case, the reservation expires after two hours, and the reserved amount is made available for other events.

A further alternative is that the event completes (block 210). The event may end prior to the depletion of authorized service units, or it may end when the authorized service units have been depleted. In some embodiments, the actual number of service units used may be used to calculate a charge that is committed to the pre-paid account. Any reserved amount in excess of the actual charge is cancelled. For example, assume that $10.00 has been reserved for a voice call, resulting in a service unit quantity of 20 minutes. Further assume that the call finishes after 16 minutes resulting in an actual charge of $8.00. In some embodiments, the original $10.00 reservation is cancelled and the actual charge of $8.00 will be committed against the account as a single transaction. Alternative transactions are possible, for example the original reservation amount of $10.00 can be committed along with a credit of $2.00 for the unused amount. Any amount left in the account is available for future use.

FIG. 3 is a flow diagram illustrating a method for determining a reservation amount according to an exemplary embodiment of the invention. The method described below refers to various constants shown in table 1 below. The constants shown below are configurable. Note that different sets of constants may be used for different call categories e.g. local versus long distance versus international. Additionally, in alternative embodiments of the invention, the constants can vary depending on the account.

TABLE 1

| Constant | Description |
|---|---|
| DefaultDurationToken | The initial duration to use when rating a |
| | reservation event. This value should be |
| | chosen, balancing probability that the |
| | reservation is successful versus maximizing |
| | the size of the reservation token size. In one |
| | embodiment, the constant is selected such that |
| | 80% of events terminate within the default |
| | duration. |
| | The DefaultDurationToken is generally greater |
| | than the MinDurationToken. |
| MinDurationToken | This is the minimum duration that is reserved |
| | for a voice call. If a subscriber does not have |
| | enough balance to pay for this amount of |
| | duration, then the call will not be authorized. |
| MaxNumberRateReturns | This is the maximum number of rate and return |
| | calls to the Rating Engine per reservation |
| | request. The minimum this value can be is 2. |
| CreditLowWaterMark | If the Available Credit for a subscriber is |
| | below this value, all of the available credit may |
| | be reserved for a call. |
| CreditPerCallPercentage | If the Available Credit for a subscriber is |
| | above the CreditLowWaterMark, then the |
| | maximum amount reserved for a single call is |
| | equal to Available Credit times the |
| | CreditPerCallPercentage. In some |
| | embodiments, if this value is less than the |
| | CreditLowWaterMark, then the maximum |
| | amount is the CreditLowWaterMark. |
| | For example, if this value is set to 50% and the |
| | available credit is $20 and the |
| | CreditLowWaterMark is $2, then the |
| | maximum amount reserved for a single call is |
| | $10. |
| | Note that on subsequent reservation extensions |
| | for the same call, the available credit will be |
| | lower, thereby adjusting the maximum amount |
| | available to reserve. |

The method begins when an event is received (block 302). Typically the event will be a request to authorize a charge against a pre-paid account. Data included with the event will be the type of call. However, the service and account associated with the event are typically not known at this point and can be supplied by the rating function described below. Next, the event data is passed to a rating function, as well as a duration equal to DefaultDurationToken (block 304). In some embodiments, the rating function is executed by a rating engine. Rating functions are known in the art, and apply tariffs and duration data to return a charge for a given call. The rating function returns the charge for the given default duration. This charge is referred to as the reservation amount. In some embodiments, the rating algorithm also identifies the account that the call should be billed to.

Next, in some embodiments of the invention a check is made to determine if the call is a free call (decision block 306). For example, the call may be to a toll free number in which case the user is not charged for the call. If the call is a free call, the method returns a successful authorization and in addition flags the call as a free call to avoid subsequent authorization requests (block 308)

Otherwise the balance manager fetches the available credit (block 310). The available credit is determined by examining the account identified by the rating function as the account associated with the event.

Decision block 312 is the top of a loop that can iteratively adjust a reservation amount until either a successful reservation can be made, or failure is detected. In some embodiments of the invention, a counter (the Rate Return count) is maintained to insure that the loop is not executed more than MaxNumberRateReturns times. This is to ensure that the system response does not degrade due to repeated execution of the rating function.

Decision block 312 checks to determine if the current reservation amount is appropriate. In one embodiment of the invention, the condition that must be met to determine that the reservation amount is appropriate is:

```
( Available Credit > reservation amount ) AND
    (
    [Available Credit <= CreditLowWaterMark] OR
    [reservation amount < Available Credit *
    CreditPerCallPercentage]
    )
```

If the current reservation amount is determined to be appropriate, then the method returns an indication of a successful authorization and the authorized duration. In addition, the current reservation amount is reserved against the account.

Otherwise, previous reservation amount is too high and a new reservation amount needs to be determined. The method proceeds to determine if the current reservation amount is less than MinDurationToken, the minimum allowed reservation amount (decision block 316). If it is, there is insufficient credit in the account to make the call. In this case, the method returns a reservation failure to the requesting application (block 318).

If the reservation amount is greater than MinDurationToken, the current reservation amount is too high, but there is sufficient credit to determine a new reservation amount and duration. A new duration is calculated that is less than the previous duration (block 320). In some embodiments of the invention, the desired reservation amount is calculated based on the available credit. In one embodiment, the following algorithm is used to calculate the desired reservation amount:

```
IF (Available Credit × CreditPerCallPercentage <=
CreditLowWaterMark)
THEN
    Desired Reservation Amount = CreditLowWaterMark
ELSE
    Desired Reservation Amount = AvailableCredit ×
CreditPerCallPercentage
```

Additionally, some embodiments of the invention calculate a new event duration using the following algorithm:

```
IF (Rate Return Count == MaxNumberRateReturns + 1)
THEN
    New Duration = MinDurationToken
ELSE
    New Duration = f(Desired Reservation Amount, Rated Charge,
Duration)
```

Where f(Desired Reservation Amount, Rated Charge, Duration) is a configurable function that returns the new duration based on the desired reservation amount, rated charge and duration. It is desirable that this function be configured such that the resultant duration is less than the duration assuming a linear per minute tariff rate. For example, if the desired reservation amount is $10, the previous reservation amount is $20 and the duration is 5 minutes, the function should return a new duration of 2.5 minutes or less.

An example function fCalcNewDuration that calculates this value is:

```
fCalcNewDuration(DesiredAmount#, RatedCharge#, Duration#)
{
    # Set the duration to be 60% of the duration for the linear rate.
    Return 0.6 * DesiredAmount# / RatedCharge# * Duration#;
}
```

The rating function or rating engine is then called with the new duration to determine a new reservation amount. In addition, in those embodiments maintaining a loop counter, Rate Return Count is incremented.

The method then returns to decision block 312 to re-execute the loop with the newly calculated reservation amount and duration.

As can be seen from the above, the method is designed to produce a reservation and call duration such that the reservation amount that is within the available credit in the user's account and the duration is long enough to be practical for a call or data connection. The method attempts to provide a reasonable balance of the following competing goals:
Maximize the size of reservations, thereby minimizing the volume of reservation extensions.
Minimize the number of times the rating function is called per reservation. Each call to the rating function can be costly in terms of performance.
Minimize the overall complexity of the algorithm. The greater the complexity, the greater the processing overhead.
Avoid coupling between the balance management processing and the rating tariffs. Ideally, the tariffs should not need to do any special processing for reservations; they should simply calculate charges for events.

It should be noted that in the discussion above, the event has been described in terms of a phone call and the service units have been expressed as a duration. However, the invention is not limited to any particular form wireless event or service unit. In alternative embodiments, the method described above and in FIG. 3 is applied to events other than phone calls and service units other than duration. For example, the event can be a content download and the service units can be tokens, messages, and byte quantities.

In some embodiments of the invention, discounts are calculated and applied to the reservation amounts determined as discussed above with respect to FIGS. 2 and 3. In some embodiments, the discount can be determined based on the tariff. In other embodiments, the discount can be configured and stored in database 104. This functionality enables a service provider to competitively differentiate their pre-paid service offerings.

Examples of such discounts include:
first call or download each day to be free
free 10 minutes of usage when cumulative usage in a week exceeds 100 minutes
familiar “Buy one and get two free” offers, where offer is only valid for long-week-end.

The discounts shown above can be applied at any step in the method, and in particular can be applied at blocks 204 and block 312 discussed above.

In some embodiments, of the invention, the system can provide Advice of charge (AoC) data. For instance, before making use of a service, a subscriber may wish to know the cost they may incur for an item of content or alternatively, the rate for volume-based or duration-based services. An example based on voice calls will be used to illustrate, however the invention is not limited to AoC for voice calls and can provide AoC for other types of services such as data downloads and content services.

Voice Call Example:

1. the IN platform 110 sends an AoC request message to balance manager 102, containing the subscriber identifier and information about the call
2. Balance manager 102 checks the available balance of the subscribers account, looks up the tariffs that match the call details and the subscribers service information, applies the reverse rating method described above and
3. returns advice of charge information. The details returned are configurable by service providers, and may include:
   available balance
   rate information such as charge per minute
   maximum possible call duration, given the current balance

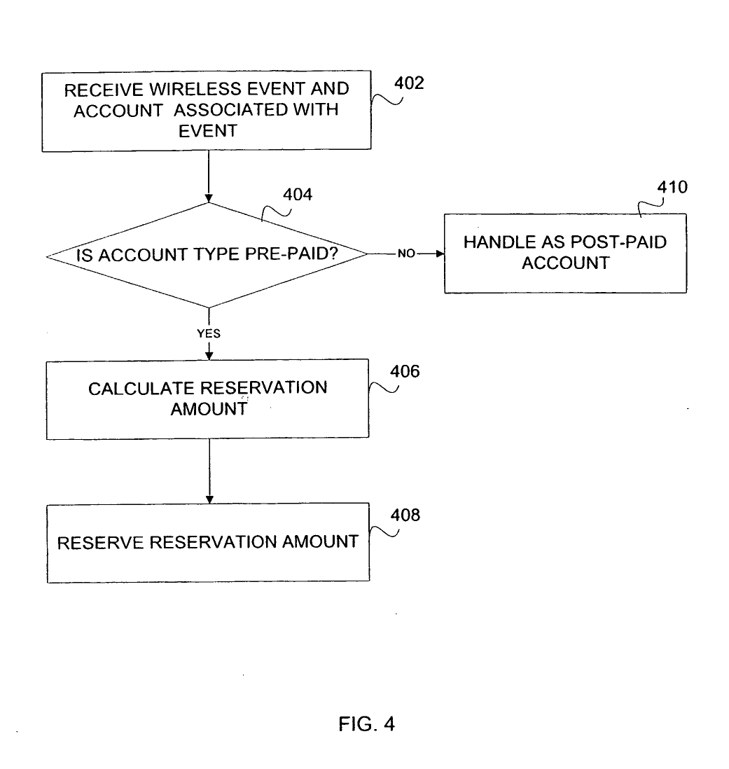

FIG. 4 is a flow diagram illustrating a method according to an exemplary embodiment of the invention for providing customer controlled account selection in an environment that includes pre-paid services. A system executing the method, such as balance manager 102, enables subscribers to control which of their accounts is used on a per session basis. For example, at the start of a voice call, a subscriber can select whether the charge is applied to their business account (which may be post-paid) or their personal account (which may be pre-paid). Alternatively, a subscriber may have a loyalty points account and may dynamically choose to pay for specific calls using loyalty points.

The method begins by receiving a wireless event, and the account selected by the user that will be associated with the event (block 402). The system then determines if the account is a post-paid or pre-paid account (block 404). If the account is post-paid, the event is handled as a post-paid event and billed as such (block 410).

If the account is a pre-paid type, the system the proceeds to determine the amount to be reserved against the account (block 406). The amount may be a fixed fee determined by a service provider, or the amount may be based on a tariff determined by a MNOP. In some embodiments, the reverse rating method described above is used to determine the reservation amount.

After determining the appropriate reservation amount, the determined amount is reserved against the account (block 408) and processing continues as described above in FIG. 2. As noted above, the amount may be currency, loyalty points, or other type of credit value. The user may continue the event, cancel the event, or terminate the event.

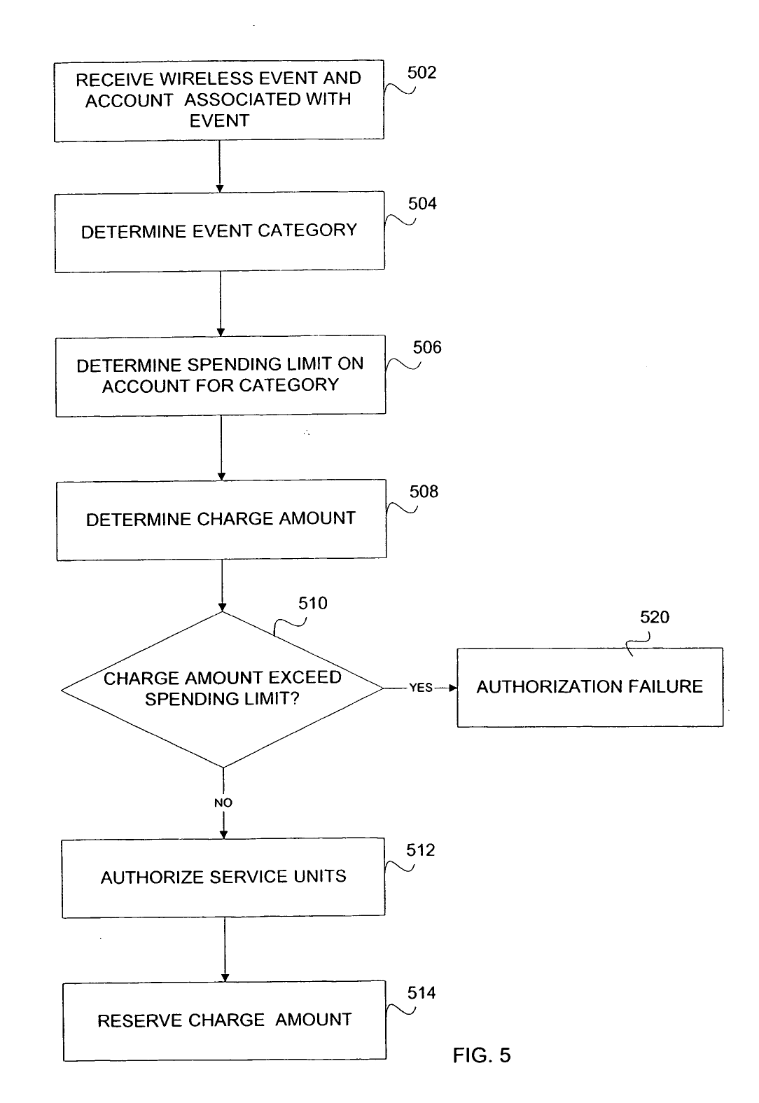

FIG. 5 is a flow diagram illustrating a method according to an exemplary embodiment of the invention for providing customer controller spending limits. In some embodiments, events can be associated with a category. Examples of such categories include voice calls, gaming, music downloads, gambling and network connectivity. In some embodiments of the invention, a account can be configured with spending limits for each supported category. For example, a mobile phone purchased for a child may be configured with the following attributes that could include: no international calls; 30 spend limit per month on voice calls; 10 spend limit per month on on-line games.

A system executing the method, such as balance manager 102, begins by receiving a wireless event and account associated with the event (block 502). Next, the system determines the event category (block 504). The event category can be provided as part of the event data, or it can be determined from the event type. Those of skill in the art will appreciate that there are various mechanisms to associate an event category with an event.

Next, the system determines the spending limit for the account and the specified category (block 506). In some embodiments, the spending limit can be configured by an authorized user of the account through a self care interface such as interface 124. In other embodiments, default spending limits can be set according to the type of account and account parameters such as user's age, time of use, etc.

Next, the system determines the amount to be charged (block 508). As described above, the amount can be a fixed fee determined by a service provider, or it can be an amount determined by reverse rating algorithm described above.

Next, the system determines if the amount to be charged would exceed the spending limit (block 510). If so, the charge is not authorized (block 520). If the amount to be charged would not exceed the spending limit, the system proceeds to authorize the appropriate service units or charge (block 512). In addition, the amount can be reserved against the account as described above (block 514).

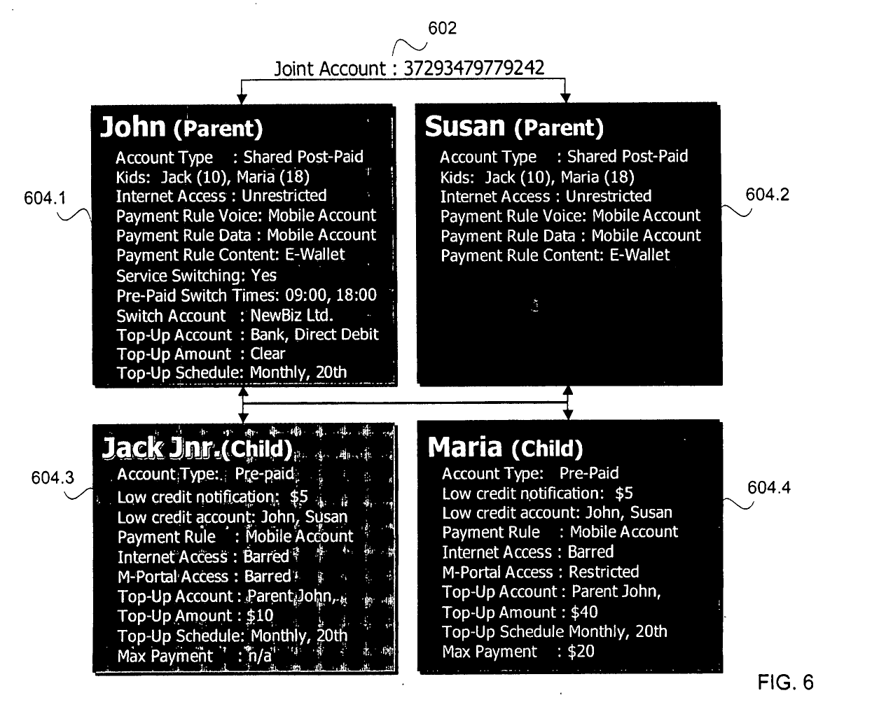

FIG. 6 is a block diagram illustrating an exemplary configuration with customer controlled spending limits, and is used in the following example of the execution of a balance management system as described above.

Assume Maria (configuration 604.4) wants to buy a ticket to see her favorite rock-band from an on-line ticket broker. She has 40 in her mobile account and selects a ticket, costing 20 and orders it. The on-line ticket broker server has detected the purchase attempt and passes the request to the M-Commerce platform 108 for processing.

The M-Commerce platform sends a Payment Options screen to Maria's mobile terminal using push transport. Maria selects the Mobile Account payment method prompting the M-Commerce platform to call the Balance Manager 102 to make a credit reservation. Credit is successfully reserved in her Mobile Account, and the M-Commerce platform is notified.

The M-Commerce platform confirms the order to the on-line ticket broker which immediately dispatches the tickets.

During Account set-up, her parents, John (configuration 604.1) and Susan (configuration 604.2) asked to be notified each time Maria made a purchase using her Mobile Account. John and Susan, now receive a text message with the transaction details.

The on-line ticket broker was informed earlier that Maria's favorite rock-band released a new song earlier that morning to mark the big concert. After Maria ordered her tickets, the on-line ticket broker sent her a message containing the URL where to download the MP3 file. Maria clicks the URL to initiate a file download.

The IN platform immediately detects Maria's terminal attempting to establish a PDP (Packet Data Protocol) context to the APN (Access Point Name) of the on-line ticket broker. The IN platform asks the Balance Manager 102 for a reservation from Maria's account to pay for the first Megabyte of the MP3 download. The Balance Manager notes that there is 20 on account so reserves 2, the per-Megabyte rate for MP3 file downloads. The MP3 file is 2.5 Megabytes to download so the IN platform makes further successful reservation attempts at 1 Megabytes and 2 Megabytes into the download. The third reservation is only half used (0.5 Megabytes) so after the download completed, a 5 charge would have been incurred and the remainder returned to the Mobile Account.

While the MP3 file was downloading, Maria rang her friend in another city to make arrangements to see her before the concert and to tell her about the new demo on MP3. This call attempt was detected by the IN platform which forwarded it the Balance Manager to reserve credit to complete the call. The Balance Manager quickly determines that the tariff is long distance and is charged at 0.50 per minute. The Balance Manager 102 sends Maria's wireless device an Advice of Charge message that reports she has only 16 on account equaling a 32 minute call at that tariff. She chooses to continue the call so the Balance Manager 102 makes a reservation of 1.00 for the first 2 minutes as required by the long-distance tariff. Maria is on the call for 4 and a half minutes long so another reservation is made at the 4 minute mark. This final reservation is only partially spent so the remaining reservation balance of 0.25 is returned to her account. After the call, her Mobile Account reads a balance of 13.75.

### Conclusion

Systems and methods for performing balance management in a pre-paid services environment are disclosed. The embodiments of the invention provide advantages over previous systems. For example, the systems and methods of the present invention provide a mechanism to determine an appropriate reservation amount that does not result complete exhaustion of the user's pre-paid account, thereby leaving credit in the account to use for other services that may be concurrently accessed. For example, a user with a pre-paid account that desires to make voice calls while simultaneously accessing a content server can do so without worrying that the entire pre-paid account will be allocated to one service thereby resulting in the denial of the other service. Additionally, multiple users of a plurality of wireless devices associated with the same pre-paid account can access the account concurrently without fear that one user will allocate the entire account resulting in the denial of service to the other user of the pre-paid account. Additionally, a user can select from multiple accounts, and can set spending limits for particular user's and event types.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

1. A computerized system comprising:
a balance manager operative to maintain a database having pre-paid accounts, said accounts having an account balance; and
a plurality of servers communicably coupled to the balance manager and further communicably coupled to a mobile network, said servers including at least one of a content server, a mobile commerce server, or an intelligent network platform server;
wherein the balance manager is operative to perform the tasks of:
receive queries from at least one of the plurality of servers,
calculate a reservation amount based on the query,
reserve the reservation amount against the pre-paid account.

2. The system of claim 1, wherein the balance manager is a replicated pair of balance managers.

3. The system of claim 1, further comprising a connector component operable to determine which of a plurality of balance managers should receive a request from the plurality of servers.

4. A computerized method for charging an account, the method comprising:
receiving event data from a wireless device, said event data including an account selection from a plurality of accounts associated with a user, said account having an account type; and
if the account type is a pre-paid account, then performing the tasks of:
calculating a reservation amount based on the event data; and
reserving the reservation amount against the selected account;
otherwise processing the event data for a post-paid account.

5. The method of claim 4, wherein the account type is a loyalty account and the reservation amount comprises loyalty points.

6. A computerized method for charging a pre-paid account, the method comprising:
receiving event data from a wireless device, said event data including a pre-paid account identifier and event type, said event type having a category;
receiving a pre-determined spending limit set within the account for the category;
determining a charge amount associated with the event;
if the charge amount does not exceed the pre-determined spending limit, then authorizing the charge amount, otherwise declining to authorize the charge amount.

7. The method of claim 6, wherein the category includes categories selected from the group consisting of: voice calls, gambling, music downloads, data downloads, internet usage.

8. A computerized method for reserving an amount against a pre-paid account in real time, the method comprising:
receiving event data;
calculating a reservation amount based on the event data;
applying a discount to the reservation amount to determine a discounted reservation amount;
determining a service unit quantity based on the discounted reservation amount; and
reserving the discounted reservation amount against the pre-paid account.

9. The computerized method of claim 8, further comprising sending the service unit quantity to a device generating the event data.
